(19) United States
(12) Patent Application Publication
(10) Pub. No.: US 2010/0086638 A1
(43) Pub. Date: Apr. 8, 2010

(54) FEED FORMULATIONS CONTAINING DOCOSAHEXAENOIC ACID

(76) Inventors: David J. Kyle, Catonsville, MD (US); John Piechocki, Odenton, MD (US); Emile Laurin, Frederick, MD (US); Walter G. Rakitsky, San Diego, CA (US)

Correspondence Address: MOORE & VAN ALLEN PLLC, P.O. BOX 13706, Research Triangle Park, NC, 27709, US

(21) Appl. No.: 12/295,688

(22) PCT Filed: Apr. 3, 2007
(86) PCT No.: PCT/US07/08409

§ 371 Date: Aug. 25, 2009

Related U.S. Application Data
(60) Provisional application No. 60/789,050, filed on Apr. 3, 2006.

(51) Int. Cl. A23K 1/16; A23K 1/18

(52) U.S. Cl. 426/2; 426/648; 426/473; 426/662

(57) ABSTRACT

The disclosure relates to an animal feed or feed ingredient containing from about 0.01% to 1.0% DHA, wherein all, or substantially all of the DHA comes from material that is of non-animal origin and the use of microbially-derived DHA at these low levels provides sufficient DHA for the optimal neurological development of the animal.

### BACKGROUND OF THE DISCLOSURE

The disclosure relates generally to the field of food supplements of algal origin, such as pet foods containing algal DHA.

Animal-derived by-products and meals are currently being added to feed formulations for companion animals. Use of animal by-products to deliver protein, fat or essential amino acids, vitamins, oils and other compounds can be problematic due to the potential for the transmission of disease. This has been recently publicized with Bovine Spongioform Encephalopathy (BSE, or mad cow disease) and the transmission of the causative agent (prions) back to the cattle through the feed in spite of extensive processing of that feed.

Vertical transmission of disease between species is also known to occur following consumption of, or contact with infected animals. This can be a significant human public health issue as exemplified by such pathologies as Creutzfeld-Jacob Disease (CJD) from the consumption of BSE-infected beef, or H5N1 influenza A from avian influenza-infected birds. Although we may not be concerned about the vertical transmission of disease from lower vertebrates {e.g., fish) or invertebrates (e.g., shrimp) to man, there are clear cases of horizontal transmission of disease in both instances. The epidemic of viruses such as White Spot Syndrome Virus (WSSV) or Taura Syndrome Virus (TSV) in shrimp, or Infectious Pancreatic Necrosis Virus (IPNV) or Infectious Salmon Anemia (ISA) in salmon, raise more concerns over the feeding of products of animal origin to other animals.

The extensive use of fish meal as a protein source, and fish oil and a fat source, in animal feeds has an additional consequence. It has devastated some fisheries such as herring, sardine, anchovy, and Menhaden, as they are harvested in mass quantities to process into fishmeal and fish oil. While they make great fish oil and fishmeal, these small fish also serve as the natural feed for the more commercially desirable fish, and the oceans are being thrown out of balance with their harvest. Besides ecological and ethical opposition to the use of finite aquatic resources as feed ingredients, and the biological concerns over horizontal and vertical transmission of disease, fishery products have become increasingly contaminated with toxic compounds (e.g., mercury, PCBs, dioxin, pesticides etc.) as many fishing grounds have become increasingly contaminated with industrial pollution.

Fish meal has been added to a substantial portion of both terrestrial and aquatic animal feeds because of its high protein digestibility and preferred amino acid composition. Until recently, a major driver for its use was its low cost. In recent years, however, the increasing costs of harvest, and the dwindling fishery supply, have resulted in significant increases in the price of fishmeal until it is now considerably higher than most vegetable protein sources even on a protein basis.

Although a lot of work has been done to develop substitutes for fishmeal and fish oil with products like soy and wheat, a high level of replacement has been generally unsuccessful. One specific benefit of the protein component of fishmeal is a high level of essential amino acids such as lysine, threonine and tryptophan, as well as the sulfur-containing amino acids methionine and cysteine. Proteins from cereal grains and most other plant protein concentrates fail to supply complete amino acid needs primarily due to a shortage of methionine and/or lysine. Soybean meal, for example, is a good source of lysine and tryptophan, but it is low in the sulfur-containing amino acids methionine and cysteine. The essential amino acids in fishmeal are also in the form of highly digestible peptides. Plant and cereal proteins generally are not in such highly digestible form, and are also accompanied by indigestible fiber. Nevertheless, Harel and Clayton (2004; International Patent Application Publication No. WO 2004/080196) have shown that it is possible to combine several different forms of cereal proteins to provide an adequate fishmeal substitute in some cases.

In addition to its protein component, fishmeal also has a relatively high content of certain minerals, such as calcium and phosphorous, as well as certain vitamins, such as B-complex vitamins (e.g., choline, biotin and B 12) and vitamins A and D.

Even though the amino acids, vitamins and minerals can all be substituted in various forms, there is still some unknown component of fishmeal that provides it with a superior impact on the development of animals. The present applicants believe that the unknown component is the essential fatty acid docosahexaenoic acid (DHA) found in the residual fish oil remaining in some fish meals after processing.

DHA is an omega-3 long chain polyunsaturated fatty acid (LC-PUFA) that is a universal structural building block of neurological tissues. DHA exhibits unique conformational characteristics that allow it to carry out a functional as well as a structural role in biological membranes of high electrical activity. The structural role involves an intimate association with certain membrane proteins such as G-protein coupled receptors and certain ion conductance proteins, which exhibit critically important functions in cell signaling and metabolic regulation. One functional role suggested for DHA involves specific control of calcium channels by the free fatty acid, thereby representing an endogenous cellular control mechanism for maintaining calcium homeostasis. DHA has been selected by nature to be a component of visual receptors and electrical membranes in various biological systems over 600 million years. It is found in simple marine microalgae, in the giant axons of cephalopods, and in the central nervous system and retina of all vertebrates (Behrens et al., 1996, J. Food Sci. 3:259-272; Bazan et al., 1990, Ups. J. Med. Sci. Suppl. 48:97-107; Salem et al., 1986, Docosahexaenoic acid: membrane function and metabolism, In: Health Effects of Polyunsaturated Fatty Acids in Seafoods, Academic Press, Inc., pp. 263-317). Indeed, in mammals it represents as much as 25% of the fatty acid moieties of the phospholipids of the gray matter of the brain and over 50% of the phospholipid in the outer rod segments of the retina (Bazan, 1994, J. Ocul. Pharmacol. 10:591-604).

As a result of its fundamental role in neurological membranes of humans, the clinical consequences of deficiencies of DHA range from the profound (e.g., adrenoleukodystrophy) to the subtle (e.g. reduced night vision) (Martinez, 1990, Neurology 40:1292-1298; Stordy, 1995, Lancet 346:385). DHA also plays a key role in brain development in humans. A specific DHA-binding protein expressed by the glial cells during the early stages of brain development, for example, is required for the proper migration of the neurons from the ventricles to the cortical plate (Xu et al., 1996, J. Biol. Chem. 271: 24711-24719). DHA itself is concentrated in the neurites and nerve growth cones and acts synergistically with nerve growth factor in the migration of progenitor cells during early neurogenesis (Dcemoto et al., 1997, Neurochem. Res. 22:671-678). The pivotal role of DHA in the development and maintenance of the central nervous system has major implications to adults as well as infants. The newly recognized, multifunctional roles of DHA may serve to explain the long-term outcome differences between breast-fed infants (getting adequate DHA from their mother's milk) and infants who are fed formulas which do not contain supplemental DHA (Anderson et al., 1999, Am. J. Clin. Nutr. 70:525-535; Crawford et al., 1998, Eur J Pediatr, 157 (Suppl 1):S23-27 {published erratum appears in February 1998 Eur. J. Pediatr. 157(2):160}). In summary, DHA is a unique molecule, which is critical to normal neurological and visual function in humans, and we need to ensure that we obtain enough of it in the diet from infancy to old age as our ability to synthesize DI-IA de novo is limited.

The DHA present in fish meal has been found by the applicants to range from 0.03% to 0.91% by dry weight depending on the amount of fish oil in the fish meal, and the extent of oxidation in the fish meal (Table 1). Other sources of DHA include animal offal and/or process byproducts (e.g., blood meal, liver, brain and other organ meats, etc.), egg-based products, and invertebrates (e.g., polychetes, crustaceans, insects and nematodes). However, DHA is not produced by conventional plant sources such as soy, corn, palm, canola, etc. and is generally provided in animal feeds in small quantities by the provision of animal byproducts. DHA, to a limited extent, can be found in aquatic plants including macroalgae (seaweed) and microalgae (phytoplankton).

TABLE 1
DHA Content of Various Commercial Fish Meals

| Sample | Fat | DHA in Fat | DHA (meal) |
|---|---|---|---|
| A | 6.9% | 0.4% | 0.03% |
| B | 6.8% | 0.4% | 0.03% |
| C | 8.1% | 3.1% | 0.25% |
| D | 10.0% | 9.1% | 0.91% |
| E | 11.2% | 6.7% | 0.75% |
| Mean | 8.6% | 3.9% | 0.39% |

Seaweed has been used as a component of animal feeds primarily for its high content of trace elements (e.g., iodine), essential vitamins (e.g., Vitamins B, D & E), antioxidants (e.g., carotenoids) and phytohormones (U.S. Pat. No. 5,715,774; He et al., 2002, J. Animal Physiol. Animal Nutr. 86:97-104). Seaweeds have recently been added to mammalian and poultry feeds as immunoenhancers to increase mammal and poultry resistance to disease (U.S. Pat. No. 6,338,856). Both seaweed meals and extracts were shown to enhance the immune responses of mammals and poultry when used to supplement the diet. Harel and Clayton (2004; International Patent Application Publication No. WO 2004/080196) have described the use of a number of seaweed meals in conjunction with plant-based protein sources as substitutes for fishmeal.

Phytoplankton have been used less extensively as a feed ingredient. The cyanobacterium (blue-green alga), Spirulina platensis, has been cultivated extensively and provides health benefits to certain animals (Grinstead et al., 2000, Animal Feed Sci. Technol. 83:237-247). Phytoplankton are a very diverse group of organisms that produce interesting bioactive compounds, vitamins, hormones, essential amino acids, and fatty acids. Pharmaceutical companies have been mining this unicellular algal kingdom for bioactive compounds for several years. Additionally, these microorganisms have the advantage of controlled growth in enclosed systems (i.e., photobioreactors or fermentors) that result in predictability of price and quality, traceability, and sustainability. Recent advances in growing certain heterotrophic phytoplankton and chytrids in conventional fermentors have advanced production of this group of organisms to a high level of economic efficiency (Boswell et al., 1992, SCO production by fermentive microalgae. In: Kyle D J, Ratledge C (eds) Industrial Applications of Single Cell Oils. American Oil Chemists Society, Champaign. IL., pp 274-286; U.S. Pat. No. 5,407,957; U.S. Pat. No. 5,518,918).

Other microbial sources of LC-PUFAs include lower plants or fungi. These have been used even less extensively as feeds. Fungal species of the genus Mortierella have been used as a source of LC-PUF A-containing oils (particularly for arachidonic acid; ARA) and have been cultivated in commercial scale fermentors for the production thereof (Kyle et al. 1998). However, neither the fungal meal nor the whole fungi have been contemplated for use as a feed ingredient.

Criggall (2002) has proposed to use a microalgal biomeal as a feed ingredient for dogs. However, Criggall proposes to use a product after extraction of the DHA-containing oil (much like soybean meal), whereas the presently-disclosed subject matter recites quite the opposite. The present applicants recognized that it is the DHA component itself which is found in the oil fraction that is the critical element for the supplementation of young animals and Criggall proposes to use the residual waste biomeal after the DHA has been removed. Other publications (Yokochi et.al, 2003; Tanaka et.al., 2003, Barclay, 2002, and Barclay, 2006) relate to the use of the lipid extract containing DHA produced from a microorganism, but not to the whole cell biomass itself. This lipid extract is used, like fish oil, for the enrichment of the edible portions of animals produced for human consumption.

Abril (2004) describes the improvement of flavor, tenderness and overall acceptability of poultry meat when fed whole cell biomass from Thraustochytriales at supplementation levels of from 200-1, 250 mg/kg/day of the highly unsaturated fatty acids (predominantly DHA). Barclay (1999) also describes raising animals using feeds prepared with biomass from Thraustochytriales for the production of edible meat or eggs that would be enriched in DHA, but for this and other patents in the same family, the feeding is generally at a stage prior to slaughter or harvest (not during the perinatal period or the first 25% of the animal's lifetime), the dose rates are exceptionally high (because of the requirement for enrichment of the edible product of the animal), and there is no reference to, or consideration of, companion or performance animals since these animals are not raised for food consumption. In Barclay (1999), for example, the algal biomass is added to the feed at levels of from 5% to 95%. This level of enrichment represents a high, but necessary quantity if one is to enrich the edible product of the animal with significant quantities of DHA. Clayton and Rutter (2004) describe the use of algal biomass (or fish oil) in combination with a carotenoid pigment (astaxanthin) for the treatment of inflammation in horses and dogs. They describe a premix concentrate containing 40% to 60% algal biomass (or 75% fish oil), which is then added to regular feeds at a rate of from 5% to 40%.

The present applicants discovered that the requirements for DHA in early neurological development of all animals are much lower than expected and certainly lower than those levels used for tissue enrichment. The applicants further discovered that optimal neurological development could be achieved at dose levels of from 0.1 to 10 mg DHA/kg/day and that this could be done by addition of an algal biomass from Schizochytrium to the feed at levels of from 0.01% up to a maximum of 2.0% of the feed. Indeed, the applicants have discovered that there is a universal requirement for the consumption of about 1 mg DHA/kg/day during the early stages of life for all mammals including, but not limited to, dogs, cats, horses, pigs, sheep, and man, in order to ensure the optimal neurological development of that mammal. Optimal neurological development is important for a number of reasons, not the least of which is so the young animal can quickly locate and move to the source of further nutrition.

### BRIEF SUMMARY OF THE DISCLOSURE

It is an object of the subject matter disclosed herein to provide a feed composition for an animal comprising DHA obtained primarily from a non-animal source in order to eliminate any possibility of vertical or horizontal disease transmission. In a preferred embodiment of this subject matter, the animal is a companion animal, and in a most preferred embodiment the companion animal is a dog or a cat.

It is an object of the subject matter disclosed herein to provide a feed composition for an animal comprising a microbial source of DHA. In a preferred embodiment of this subject matter, the microbial source of DHA is produced in a fermentor and in a most preferred embodiment of this subject matter, the microbial source of DHA is Crypthecodinium, Schizochytrium, Thraustochytrium or Ulkenia.

It is an object of the subject matter disclosed herein to provide a feed composition containing DHA from a non-animal source at a dose that is optimal for the neurological development of that animal, wherein the animal is a pregnant or nursing female providing DHA for her offspring, or the young animal itself from birth through the first 25% of its lifetime. In a preferred embodiment of the subject matter the animal may be an agricultural animal including, but not limited to, pigs, cattle, sheep, and poultry, a companion animal including, but not limited to, dogs and cats, or a performance animal including, but not limited to, horses. In a preferred embodiment of the subject matter, the DHA dose is from 0.1 to 10 mg DHA/kg/day. In a more preferred embodiment the DHA dose is from 0.5 to 5 mg/kg/day.

It is an object of the subject matter disclosed herein to provide a method for preparation of an animal feed containing DHA from a non-animal source wherein the DHA source contains no ethoxyquin, or other quinone-based or aromatic antioxidants (e.g., BHT or TBQ) and the feed can be used throughout the lifetime of the animal. In a preferred embodiment of the subject matter, the animal feed is for a companion animal or a performance animal, and in a most preferred embodiment of the subject matter, the animal feed is for a dog, cat, or horse.

The applicants have discovered a method and a product for the addition to animal feed that will provide optimal neurological development to an animal without the need for inclusion of animal byproducts in the feed, and without the risk of pathology associated with the use of animal byproducts.

Recent developments in the United Kingdom and elsewhere have cast doubt on the safety of the utilization of animal products in animal feeds destined for human consumption. Transfer of infectious agents to the animal being fed is a very real danger. The spread of bovine spongioform encephalitis (BSE), or certain viruses (e.g., WSSV and TSV) have been proven to be refractory to destruction during processing. Additionally, the current dependence of fishmeal and fish oil has resulted in environmental damage by destruction of the wild fisheries used by the higher food chain predatory fish (and cetaceans) with the resulting decreases in ocean productivity. Therefore, this disclosure provides a novel approach to a real and pressing problem.

The subject matter disclosed herein utilizes the whole cell biomass from microbial sources to provide DHA to feed formulations at the levels required for optimal neurological development, such that the need for animal-derived materials (e.g., fish meal, fish oil, or other animal byproducts) is either completely or substantially eliminated. The subject matter disclosed herein further provides a method whereby the DHA in these feed formulations is unaffected by standard manufacturing processes such as extrusion and/or pelleting without using certain chemical antioxidants that are restricted from, or of limited use in foods or feeds.

### BRIEF SUMMARY OF THE SEVERAL VIEWS OF THE DRAWINGS

FIG. 1 is a graph which shows the growth of salmon fry fed different diets.

FIG. 2 is a bar graph which shows puppy preference for diets prepared with a microbial DHA source (diet 1) and fish oil (diet 5).

FIG. 3 is a bar graph which shows panel preference data obtained from 55 female consumers assessing fresh (solid bars) and aged (striped bars) puppy diets prepared with microbial DHA (diets 1-3) or fish oil DHA (diets 5-6).

FIG. 4 is a bar graph which shows the course of oxidation measured by peroxide value in puppy diets prepared with microbial DHA (Algae diets 1-3) or fish oil DHA (diets 5-6) initially (lightest bar, on left side of bar triplets), after one month (intermediate darkness bar, in center of bar triplets), and after two months (darkest bar, on right side of bar triplets).

### DETAILED DESCRIPTION OF THE DISCLOSURE

The subject matter disclosed herein relates generally to the field of food supplements of algal origin, such as pet foods containing algal DHA.

### Definitions

As used herein, each of the following terms has the meaning associated with it in this section.

The term “fishmeal” is used to describe a crude preparation or hydrolysate from fish of any species or mixed species that is processed into a solid or semi-solid form for easy use.

The term “fish oil” refers to any oil extracted from fish, in any form and purity. Usually in feed terms, “fish oil” is used to describe a fairly crude preparation but can also encompass a highly purified form used as a human food supplement.

The term “animal meal” is used to as a group descriptor to include fishmeal, meat meal, blood meal, beef extracts, and other animal-derived feed supplements.

The term “animal-derived” is used to describe any product produced from animals.

The terms “macroalgae” and “seaweed” refer to algae that in at least one life stage form large structures that are easily discernable with the naked eye. Usually these organisms have secondary vascularization and organs. Examples of different groups containing macroalgae follow but are not limited to the chlorophyta, rhodophyta and phaeophyta. For the purposes herein these terms will be used synonymously.

The term “microbe” refers to any single cell organisms and includes algae, bacteria, cyanobacteria, and lower fungi. Such microbial organisms are typically produced in a fermentor and the “microbial biomass” refers to the entire cell mass of the microbe.

The term “microalgae” refers to prokaryotic and eukaryotic algae (e.g. Crypthecodinium cohnii) and chytrids (e.g., Schizochytrium, Thraustochytrium, Ulkenia) that are microscopic in size. Normally the prokaryotic algae are referred to as cyanobacteria or bluegreen algae. The eukaryotic microalgae and chytrids come from many different genera, some of which overlap with the macroalgae and are differentiated from these by their size and a lack of defined organs (although they do have specialized cell types). Examples of different groups containing microalgae include, but are not limited to, the chlorophyta, rhodophyta, phaeophyta, dinophyta, euglenophyta, cyanophyta, prochlorophyta, cryptophyta, and Thraustchytriales.

The term “lower fungi” refers to fungi that are typically grown in fermentors by providing appropriate carbon and nitrogen sources. Examples of such lower fungi would include, but are not limited to, yeasts (e.g., Saccharomyces, Phaffia, Pichia, and etc.), filamentous fungi (Mortierella, Saprolegnia, Pythium, and etc.).

The term “food supplement”, “feed supplement” or “enrichment product” refers to products having one or more nutritional substances in concentrated form (mainly vitamins, minerals and trace elements), usually presented in formats such as premixes, that are added to a complete diet or added separately as tablets, pellets or beads to be consumed directly. Food or feed supplements or enrichments are not meant to fulfill the complete nutritional needs of the animal, but provide some specific benefit. For the purposes herein these terms will be used synonymously.

### DETAILED DESCRIPTION

The present disclosure relates to an animal feed composition comprising DHA from a microbial source produced by fermentation of microalgae and/or lower fungi and its use to provide the optimal neurological development in an animal in the absence of any substantial DHA contribution from animal byproducts. These, and other embodiments of the subject matter disclosed herein, are provided by one or more of the following embodiments.

One embodiment of the subject matter disclosed herein is a feed or feed ingredient wherein all animal products are eliminated and the feed contains a microbial biomass containing DHA from one or more species selected from, but not limited to, the following organisms, Crypthecodinium, Tetraselmis, Nitzschia, Schizochytrium, Thraustochytrium, Ulkenia, Shewanella and Mortierella.

In another embodiment of the subject matter disclosed herein, a method is provided for production of a feed or feed ingredient containing a microbial source of DHA that will replace the use of animal meal, fishmeal or fish oil in feeds used for terrestrial animals, wherein the microbial DHA source is added to the feed in the absence of ethoxyquin.

In another embodiment of the subject matter disclosed herein, a method is provided to optimize the neurological development of a terrestrial animal using a feed or feed ingredient for the pregnant or lactating mother, or as a direct feed for the young animal through the first 25% of its lifetime, wherein said feed or feed ingredient contains a microbial source of DHA at a level required for the optimal neurological development for that animal.

### EXAMPLES

The subject matter disclosed herein is now described with reference to the following Examples. These Examples are provided for the purpose of illustration only, and the invention is not limited to these Examples, but rather encompasses all variations which are evident as a result of the teaching provided herein.

### Example 1

### Preparation of Microalgal DHA Biomass

Heterotrophic microalgae containing DHA, such as Crypthecodinium spp., or Schizochytrium spp., are cultured in industrial fermentors using glucose as a source of energy by following established culturing procedures (U.S. Pat. No. 5,407,957; U.S. Pat. No. 5,518,918). The microbial biomass is then harvested directly and centrifuged to produce a thick paste, dried (drum drying, spray drying or the like), and ground into a fine powder. Under circumstances where high oxidative stability of the biomass is required, lecithin is added to the centrifuged paste at a level of from 1-20 g lecithin/40 gdw of the paste and mixed before drum drying or spray drying.

Schizochytrium biomass was cultured in a 2 L fermentor for 60 hr according to Barclay (1996). The biomass was harvested, mixed with liquid lecithin (Yelkin 1018; Tilley Chemicals, Baltimore, Md.) at a ratio of 4 parts Schizochytrium biomass (dry weight basis) with 1 part lecithin, and spray dried. The resulting biomass had a fatty acid profile shown in Table 2. Crypthecodinium biomass produced according to Kyle (1998) was obtained from Martek Biosciences Corp (Columbia, Md. USA), and it had a fatty acid profile shown in Table 2. Neither biomass product was treated with ethoxyquin.

Crude oil from Crypthecodinium biomass produced according to Kyle (1998) by hexane extraction of the biomass. The Crude oil was then refined and the refining waste (a mixture of gums, free fatty acids and oil in the form of an emulsion with water) was mixed with yeast and spray dried. Although not intact biomass, this DHA-rich material can also be used in the examples described below.

TABLE 2
Fatty Acid Composition of Crypthecodinium and Schizochytrium
Biomass in Percent of Total Fatty Acids.

| fatty acid | Schizochytrium | Crypthecodinium |
|---|---|---|
| C12:0 | 0.3 | 4.1 |
| C14:0 | 8.6 | 16.5 |
| C16:0 | 21.8 | 16.9 |
| C16:1 | 0.4 | 0 |
| C18:0 | 0.5 | 0 |
| C18:1 | 0.2 | 10.2 |
| C18:2 | 1.5 | 0 |
| C18:3 | 0.2 | 0 |
| C20:4 | 2.2 | 0 |
| C20:5 | 1 | 0 |
| C22:5 | 17 | 0 |
| C22:6 | 40.2 | 39.2 |

The lecithin-stabilized Schizochytrium biomass had an oxidative stability similar to that of ethoxyquin-stabilized biomass, and much higher than the biomass without lecithin stabilization. Drum-dried Schizochytrium biomass samples with and without ethoxyquin were produced according to Barclay (1996) and provided by Martek Biosciences Corp (Columbia, Md.). Lecithin (Yelkin 1018) was dry-blended to Schizochytrium biomass samples without ethoxyquin at a level of 5 g lecithin to 95 g biomass (i.e., 5% lecithin). The resulting products were placed under conditions reflecting an accelerated oxidation environment (open trays, 100C₅ 16 hr). Samples were taken before and after treatment and the peroxide values (PVs) were determined. The PVs of all samples are shown in Table 3.

TABLE 3
Stability Profile of Schizochytrium Biomass Stabilized with Lecithin.

| Sample | Lecithin | Time | PV (meq/kg) |
|---|---|---|---|
| Schizochytrium | no | 0 | 5.8 |
| Schizochytrium | no | 16 | 88 |
| Schizochytrium | yes | 16 | 7.6 |

### Example 2

### Preparation of a Dog Diet Containing Microbial DHA Biomass

Puppy chow diets were prepared using a standard puppy chow recipe (Table 4) but with the inclusion of Schizochytrium biomass+lecithin (5%) as described in Example 1 or top coated with fish oil+ethoxyquin. The algal biomass was added at a level of 0.1% DHA or 4 g Schizochytrium biomass per kg regular puppy chow. This mixture was extruded into small kibbles about 0.8×1.0 cm in size. Similar kibbles were prepared without the microalgal biomass and then top coated with fish oil to provide the same level of DHA as those with the microalgal biomass. The kibbles were immediately tested for oxidation by determining the peroxide value and then retested after 30 days storage in an open container at room temperature. Consumer panel testing was also undertaken before and after storage treatment. The resulting data (Table 5) clearly indicated the superior performance of the kibbles prepared with the intact microalgal biomass relative to the fish oil top coating to provide the same amount of DHA.

TABLE 4
Puppy Food Composition Containing 0.1% DHA
on a Dry Weight Basis.

| Component | % of diet |
|---|---|
| Schizochytrium Biomass | 0.40 |
| Chicken by-product meal | 33.50 |
| Corn | 23.00 |
| Brewers Rice | 21.50 |
| Pizzeys Flax | 4.60 |
| Beet Pulp | 2.90 |
| Brewers Dried Yeast | 0.88 |
| Egg | 0.75 |
| Salt | 0.63 |
| K Chloride | 0.63 |
| Vitamins | 0.20 |
| Minerals | 0.05 |
| Oxygon | 0.03 |

TABLE 5
Oxidation and Consumer Panel Results from Fresh
and Aged Puppy Chow Containing DHA
from Schizochytrium Biomass vs. Fish Oil.

| Metric | Schizochytrium + lecithin | Fish oil + ethoxyquin |
|---|---|---|
| Initial PV (mEq/kg) | 4.0 | 12.6 |
| Final PV (mEq/kg) | 5.2 | 23.8 |
| Initial smell preference | good | fair |
| Final smell preference | good | bad |

### Example 3

### Preparation of a Cat Diet Containing Microbial DHA Biomass

A standard diet for cats is prepared according to the recipe in Table 6. Crypthecodinium biomass prepared according to Example 1 is added to the formulation at a level of 5 grams of biomass per Kg of cat diet and the resulting composition is mixed well into a dough and rolled our to a thickness of one-eighth of an inch. The rolled-out dough is then placed on a greased cookie sheet and baked at 350° F. until golden brown. Once cool, the mixture can be broken into bite-sized pieces. Alternatively, the mixture can be directly extruded into small pellets of 0.8×1.0 cm in size. These pellets are then top coated with a small amount of chicken fat as a flavoring agent and can be provided directly to the cat in this form.

TABLE 6
Composition of a Typical Cat Diet Containing Microalgal DHA.

| Component | % of diet |
|---|---|
| Crypthecodinium Biomass | 0.5 |
| Ground Chicken | 27.4 |
| Chicken Broth | 21.8 |
| Brown Rice Flour | 15.6 |
| Rye Flour | 10.5 |
| Whole Wheat Flour | 10.0 |
| Wheat Germ | 9.5 |
| Vegetable Oil | 3.2 |
| Brewers Yeast | 1.2 |
| Dried Alfalfa | 0.3 |

### Example 4

### Preparation of a Horse Diet Containing Microbial DHA Biomass

A daily nutritional formulation for a horse is prepared including DHA using the recipe shown in Table 7. Several ingredients are used to make up the carbohydrate, fat and protein component of the feed including flax seed, flax oil. rice bran, whey protein, sunflower seed, soy flour, and cane molasses. All materials are blended well and the resulting mixture is used either as a top dress for feeds, or as a full feed itself. For ease of consumption the feed can also be pelleted and provided as a full feed in the pelleted form.

TABLE 7
Horse Diet Containing DHA at a Dose Level of 1 g/kg diet.

| Component | % of diet |
|---|---|
| Schizochytrium Biomass | 0.5 |
| Carbohydrate | 32.0 |
| Crude Fat | 28.5 |
| Crude Protein | 18.0 |
| Ash | 12.0 |
| Crude fiber | 9.0 |

### Example 5

### Preparation of a Sow Diet Containing Microbial DHA Biomass

Swine feed is formulated with the ingredients listed in Table 8 and designed to include at least 20% protein and 6% lipid. To the standard swine feed is added Schizochytrium biomass at a level of 1 Kg per ton of feed (0.1%). This dose represents 0.02% DHA in the overall feed. Assuming a 200 kg sow consumes 3 kg of feed per day and each Kg of feed contains 1,000 mg Schizochytrium biomass (200 mg DHA), the overall daily dose consumed is 1 mg DHA/kg/day.

TABLE 8
Swine Feed Prepared to Deliver 1 mg DHA/kg/day.

| Component | % of diet |
|---|---|
| Schizochytrium Biomass | 0.10% |
| Wheat grain | 33.30% |
| Barley grain | 20.00% |
| Soy protein (and/or pea protein) | 15.00% |
| Corn grain | 15.00% |
| Soy oil | 5.00% |
| Minerals mix | 2.50% |
| Trace element mix | 0.10% |
| Vitamins mix | 0.10% |

### Example 6

### Preparation of a Shrimp Diet Containing Microbial DHA Biomass

Shrimp feed is formulated with the ingredients listed in Table 9 using standard methods. The grow-out feed is designed to include at least 30% protein. 6% lipids and 0.05% DHA. The ingredient mix is then extruded to 3-10 mm pellet size using a standard pellet extruder and fed directly to shrimp.

TABLE 9
Diet composition for grow-out diet for shrimp.

| Component | % of diet |
|---|---|
| Schizochytrium Biomass | 0.25% |
| Soy protein concentrate | 38% |
| Wheat meal | 33% |
| Soy oil | 4% |
| Mineral mix | 1% |
| Vitamins mix | 0.50% |
| a-Tocopherol | 0.50% |
| Ascorbic acid | 0.50% |
| Cholesterol | 0.50% |
| Betaine | 0.50% |
| Glycine | 0.50% |
| Lysine | 0.50% |
| Methionine | 0.50% |

### Example 7

Preparation of a Dog Treat Containing Microbial DHA Biomass. [0072] The microalgal biomass produced in Example 1 has a very high DHA content (20-25% DHA) and can be used to produce dog treats that deliver a daily dose of DHA in a small “one-a-day” treat. DHA-enriched treats were prepared by using a conventional dog treat composition as shown in Table 11. Schizochytrium biomass was blended into this mixture using one part Schizochytrium biomass to 9 parts basic dog chow. Up to about 18% algal biomass (1 part algal biomass plus 5 parts basic dog chow) can be incorporated into this mixture and still produce an acceptable extruded product. At a 10% admix, a 1.0 g treat will contain about 20 mg DHA. At 18% admix, a 1.0 g treat contains 36 mg DHA. At a recommended dose of 1 mg/kg/day this 1 g treat would be adequate for the daily allotment for a dog of 20-40 kg.

TABLE 11
Recipe for a One-a-Day DHA Dog Treat Containing 36 mg DHA/g Treat.

| Component | % of diet |
|---|---|
| Schizochytrium Biomass | 18.0 |
| Rice Flour | 41.0 |
| 2nd Clear Wheat Flour | 16.4 |
| Corn Gluten Meal | 16.4 |
| Wheat Gluten Meal | 8.2 |

### Example 8

### Preparation of a Dog Treat Containing Microbial DHA Extract

The microalgal DHA oil process waste material produced in Example 1 has a DHA content of about 30% of the lipid and a lipid content of about 50% of the total dry weight. This material is very stable and does not need to be further stabilized with ethoxyquin and can be used directly to produce dog treats that deliver a daily dose of DHA in a small “one-a-day” treat. DHA-enriched treats are prepared by using a conventional dog treat composition as shown in Table 11. Crypthecodinium DHA material of Example 1 is blended into this mixture using one part Crypthecodinium DHA material to 9 parts basic dog chow. At a 10% admix, a 1.0 g treat will contain about 15 mg DHA (1.5% DHA). Using a 1% admix, a 1.0 g treat would contain 1.5 mg DHA (0.15% DHA). Using a 0.5% admix (0.075% DHA), a 5.0 g treat would provide 3.75 mg DHA. At a recommended dose of 1 mg/kg/day this 5 g treat would be adequate for the daily allotment for a dog of 3-5 kg (7-12 pounds).

### Example 9

### Preparation of a Salmon Diet Containing Microbial DHA Biomass

The feasibility of partial or total fishmeal/fish oil replacement in Atlantic salmon diets was tested using a blend of vegetable, animal and/or high-docosahexaenoic acid (DHA) algal-DHA (S-Type Gold Fat, Advanced BioNutrition Corp). Atlantic salmon fry (−4 g starting weight) were fed 8 different experimental extruded-pellet diets (Table 12, Diets 2 to 9) and a commercial extruded-pellet diet (Table 12, Diet 1).

| | Percentage of Each Ingredient | | | | | | | | |
|---|---|---|---|---|---|---|---|---|---|
| | Diet 1 | Diet 2 | Diet 3 | Diet 4 | Diet 5 | Diet 6 | Diet 7 | Diet 8 | Diet 9 |
| Schizachytrium biomass | | 5.0 | | 5.0 | | 5.0 | | 5.0 | |
| Vegi mix | | | 20.0 | 20.0 | | | 20.0 | 20.0 | 20.0 |
| Blood cell meal AP301 | 12.0 | 12.0 | 14.0 | 14.0 | 11.5 | 11.5 | 12.5 | 12.5 | 12.5 |
| Corn gluten meal | 18.0 | 19.0 | 19.0 | 19.0 | 19.0 | 19.0 | 19.5 | 19.5 | 19.5 |
| Soybean meal | 7.0 | 5.0 | 5.5 | 3.0 | 6.0 | 4.5 | 6.0 | 5.0 | 6.0 |
| Herring meal | 40.0 | 40.0 | 20.0 | 20.0 | 20.0 | 20.0 | | | |
| Poultry by-product meal | 0.0 | 0.0 | 0.0 | 0.0 | 20.0 | 20.0 | 20.0 | 20.0 | 20.0 |
| Wheat, grain | 6.0 | 4.0 | 3.0 | 2.0 | 7.0 | 5.5 | 4.0 | 2.0 | 4.0 |
| Celite | 1.0 | 1.0 | 1.0 | 1.0 | 1.0 | 1.0 | 1.0 | 1.0 | 1.0 |
| CaHPO4 | 1.7 | 1.7 | 2.4 | 2.4 | 1.1 | 1.1 | 1.8 | 1.8 | 1.8 |
| Vitamin/Mineral premix | 1.0 | 1.0 | 1.0 | 1.0 | 1.0 | 1.0 | 1.0 | 1.0 | 1.0 |
| Flax oil | | 13.0 | | 15.0 | | 12.5 | | 14.0 | 16.0 |
| Fish oil | 15.0 | | 16.5 | | 14.5 | | 16.0 | | |
| Total (%) | 100.0 | 100.0 | 100.0 | 100.0 | 100.0 | 100.0 | 100.0 | 100.0 | 100.0 |

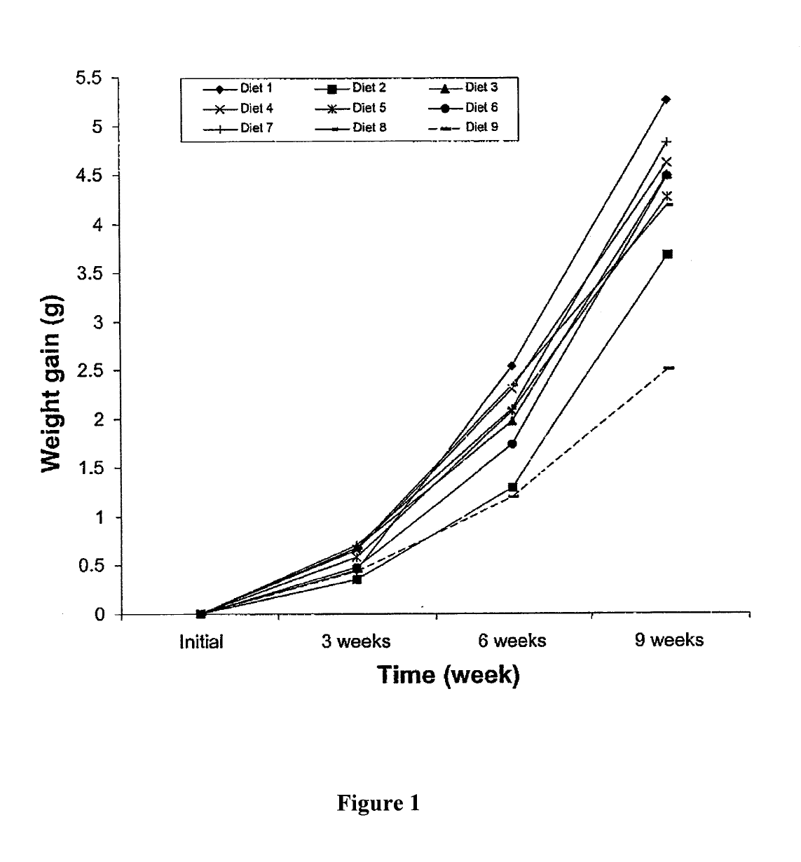

All diets were formulated to the same crude fat, crude protein and energy basis. Four replicates of 10 fry per treatment were weighed prior to the experiment then periodically sampled at 3, 6 and 9 weeks. After the 9-week growth trial, fish fed diet 4, a 50% fishmeal substitution by a 50% vegetarian protein blend combined with 100% flax oil+algal-DHA, showed no significant differences compared to the fish fed on commercial diet (100% fishmeal and 100% fish oil) (FIG. 1). Fish fed on diet 9 (100% flax oil, without the addition of algal-DHA and 100% replacement with non-marine protein) had the worst growth rate compared to all other diets, indicating that DHA is essential to obtain equivalent growth performance of juvenile salmon fed on commercial diets. Therefore, we suggest that diet 4 is suitable to support the growth of salmon as well as to significantly reduce the amount offish by-product used in feed dedicated to salmon farming.

### Example 10

### Stability and Sensory Evaluation of Puppy Food Formulated With Microbial DHA or Fish Oil

Puppy food was prepared with either Schizochytrium biomass or fish oil and studied to note the effect of enriching the puppy food with DHA from these two sources on the oxidative stability and odor profiles of the finished diets. Dog palatability, stability of the product, and buyer's perceptions were evaluated. Standard puppy food diets were prepared with the compositions shown in Table 13.

TABLE 13
Composition of puppy diets prepared with microbial biomass (whole cells of Schizochytrium)
or with Menhaden fish oil and stabilized with ethoxyquin, mixed tocopherols or lecithin.

| Diet Number | Diets | Moisture (%) | Fat (%) | Protein (%) | Fiber (%) | Ash (%) | DHA (%) |
|---|---|---|---|---|---|---|---|
| 1 | Biomass + ethoxyquin | 5.48 | 14.49 | 28.6 | 1.33 | 6.58 | 0.10 |
| 2 | Biomass + tocopherols | 4.98 | 14.73 | 30.4 | 1.56 | 6.81 | 0.11 |
| 3 | Biomass + Lecithin | 6.50 | 13.84 | 28.5 | 1.36 | 6.64 | 0.11 |
| 5 | Menhaden Oil + ethoxyquin | 4.50 | 15.97 | 28.4 | 1.39 | 6.75 | 0.12 |
| 6 | Menhaden Oil + tocopherols | 4.72 | 15.33 | 29.5 | 1.35 | 6.76 | 0.14 |

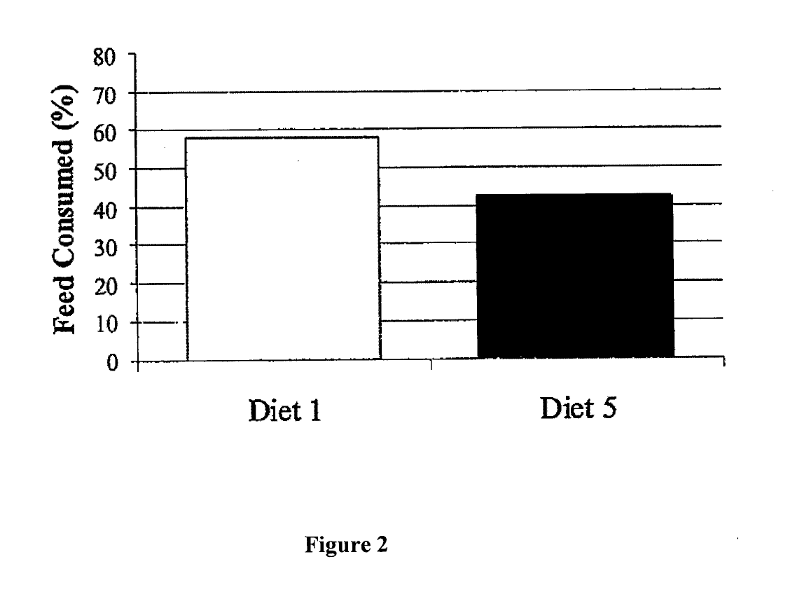

All prepared diets were tested immediately after preparation (fresh) and after one and two months storage at room temperature in an open bag (oxidized). Standard puppy taste preference tests indicated that although the puppies preferred the diets prepared with the microbial DHA source over the fish oil preparations, the sample size was too small to show statistical significance, as shown in FIG. 2.

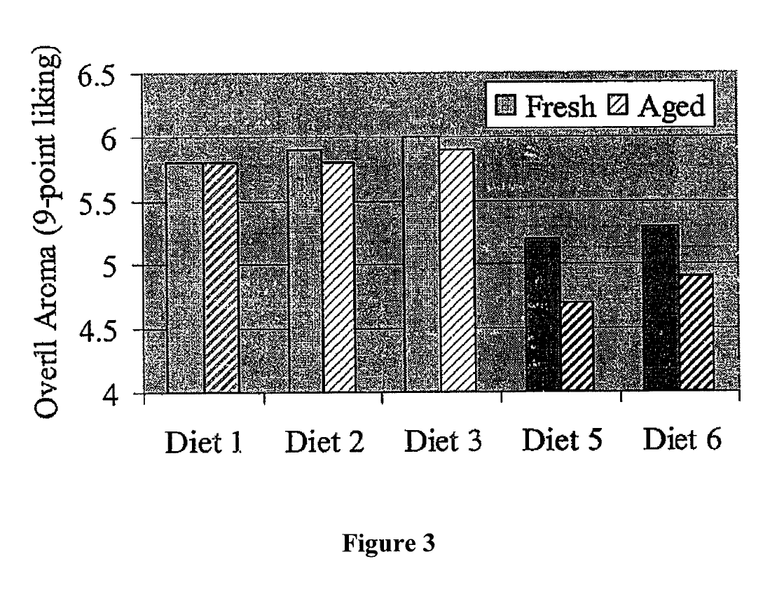

A consumer panel was used to test general preferences based on odor and texture of the puppy diets. Consumers rated the aroma of the fresh samples of the three diets containing the microbial DHA source similarly in both the fresh and oxidized form. However the fish oil based puppy diets scored significantly lower in the fresh samples and even worse in the oxidized samples compared to the microbial DHA prepared diets, as shown in FIG. 3.

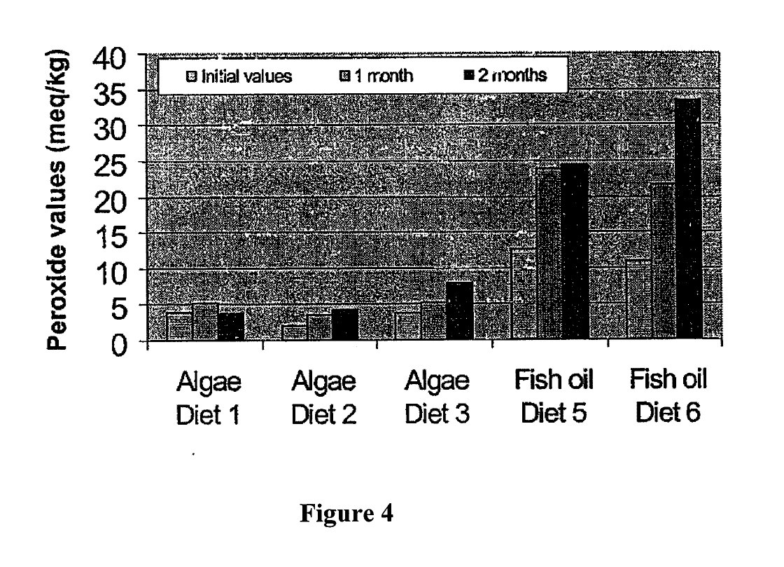

The puppy foods prepared and treated as described above were also tested for degree of oxidation by measurement of the peroxide value (PV). All diets prepared with the microbial DHA. source started off with a lower PV than the fish oil prepared diets indicating the improved stability of the microbial DHA sourced material on passage through extrusion. Furthermore, the diets prepared with the microbial DHA were more stable (lower PVs) with aging compared to the fish oil based diets even when the fish oil was stabilized with ethoxyquin, as shown in FIG. 4.

### REFERENCES CITED

The following references are cited herein.
Abril J R (2004) Method of improving the flavor, tenderness and overall consumer acceptability of poultry meat (U.S. Pat. No. 6,716,460).
Adey W H, Purgason R (1998) Animal feedstocks comprising harvested algal turf and a method of preparing and using the same. (U.S. Pat. No. 5,715,774). [0090] Allen V, Pond K (2002) Seaweed supplement diet for enhancing immune response in mammals and poultry. (U.S. Pat. No. 6,338,856).
Anderson, J. W., Johnstone, B. M. and Remley, D. T. (1999). Breast-feeding and cognitive development: a meta-analysis [see comments]. Am J Clin Nutr, 70, 525-35.
Barclay W R (1996) Microfloral biomass having Omega-3 Highly Unsaturated Fatty Acids (U.S. Pat. No. 5,518,918).
Barclay W R (1999) Food product containing thraustochytrium and/or schizochytrium microflora and an additional agricultural based ingredient (U.S. Pat. No. 5,908,622).
Barclay W R (2002) Fermentation process for producing long chain omega-3 fatty acids with euryhaline microorganisms (U.S. Pat. No. 6,451,567).
Barclay W R (2006) Method of producing lipids by growing microorganisms of the order thraustochytriales (U.S. Pat. No. 7,005,280).
Bazan, N. G. and Scott, B. L. (1990). Dietary omega-3 fatty acids and accumulation of docosahexaenoic acid in rod photoreceptor cells of the retina and at synapses. Ups J Med Sci Suppl, 48, 97-107.
Bazan, N. G. and Rodriguez de Turco, E. B. (1994). Review: pharmacological manipulation of docosahexaenoic-phospholipid biosynthesis in photoreceptor cells: implications in retinal degeneration. J Ocul Pharmacol, 10, 591-604.
Behrens, P. and Kyle, D. (1996). Microalgae as a source of fatty acids. J Food Sci, 3, 259-272.
Boswell K D B, Gladue R, Prima B, Kyle D J (1992) SCO production by fermentive microalgae. In: Kyle D J, Ratledge C (eds) Industrial Applications of Single Cell Oils. American Oil Chemists Society, Champaign. IL., pp 274-286.
Harel M and D Clayton (2004) Feed Formulation for Terrestrial and Aquatic Animals. (International Patent Application Publication No. WO 2004/080196).
Clayton D and R Rutter (2004) Inflamatory Disease Treatment (International Patent Application Publication No. WO 2004/112776).
Crawford, M. A., Costeloe, K., Ghebremeskel, K. and Phylactos, A. (1998). The inadequacy of the essential fatty acid content of present preterm feeds [published erratum appears in Eur J Pediatr 1998 February; 157(2):160]. Eur J Pediatr, 157 Suppl 1, S23-7.
Criggal J G, NB Trivedi and J R Hutton (2002) Pet foods using algal or fungal waste containing fatty acids (U.S. Pat. No. 6,338,866).
Grinstead G, Tokach M, Dritz S, Goodband R, Nelssen J (2000) Effects of Spirulina platensis on growth performance of weanling pigs. Animal Feed Sci Technol 83:237-247.
He M L, Hollwich W, Rambeck W A (2002) Supplementation of algae to the diet of pigs: a new possibility to improve the iodine content in the meat. J Animal Physiol Animal Nutri 86:97-104.
Dcemoto, A., Kobayashi, T., Watanabe, S, and Okuyama, H. (1997). Membrane fatty acid modifications of PC12 cells by arachidonate or docosahexaenoate affect neurite outgrowth but not norepinephrine release. Neurochem Res, 22, 671-8.
Kyle D J (1997) Arachidonic Acid and Methods for the Production and Use Thereof (U.S. Pat. No. 5,658,767).
Kyle D J, Reeb S E, Sicotte V J (1998) Production of DHA by Dinoflagellates (U.S. Pat. No. 5,407,957).
Martinez, M. (1990). Severe deficiency of docosahexaenoic acid in peroxisomal disorders: a defect of delta 4 desaturation. Neurology, 40, 1292-8.
Salem, N. J., Kim, H-Y., and Yergey, J. A. (1986). Docosahexaenoic acid: membrane function and metabolism. In Health Effects of Polyunsaturated Fatty Acids in Seafoods pp. 263-317. Academic Press, Inc.
Stordy, B J. (1995). Benefit of docosahexaenoic acid supplements to dark adaptation in dyslexics [letter; comment]. Lancet, 346, 385.
Tanaka S, T Yaguchi, S Shimizu, T Sogo and S Fujikawa (2003) Process for preparing docosahexaenoic acid and docosapentaenoic acid with ulkenia (U.S. Pat. No. 6,509,178).
Xu, L. Z., Sanchez, R., SaIi, A. and Heintz, N. (1996). Ligand specificity of brain lipid-binding protein. J Biol Chem, 271, 24711-9.
Yokochi T, T Nakahara, T Higashihara, S Tanaka and T Yaguchi (2003) Microorganisms capable of producing highly unsaturated fatty acids and process for producing highly unsaturated fatty acids by using the microorganisms (U.S. Pat. No. 6,582,941).

The disclosure of every patent, patent application, and publication cited herein is hereby incorporated herein by reference in its entirety.

While this invention has been disclosed with reference to specific embodiments, it is apparent that other embodiments and variations of this invention can be devised by others skilled in the art without departing from the true spirit and scope of the invention. The appended claims include all such embodiments and equivalent variations.

1. An animal feed composition comprising DHA from a microbial source, wherein the microbial source provides the primary source of DHA in the animal feed.

2. The composition of claim 1, wherein the microbial source of DHA is from intact cells of Crypthecodinium or Schizockytrium or lipid extracts therefrom.

3. The composition of claim 1, wherein said feed contains from about 0.01% to 1.5% DHA.

4. The composition of claim 1, wherein said feed contains from about 0.025% to 0.25% DHA.

5. The composition of claim 1, wherein the animal is selected from the group consisting of dog, cat, horse, pig, shrimp and salmon.

6.-12. (canceled)

13. The composition of claim 1, wherein the DHA dose provided to the animal is between 0.1 and 10 mg DHA/kg/day.

14. The composition of claim 1, wherein the DHA dose provided to the animal is between 0.5 and 5.0 mg DHA/kg/day.

15. The composition of claim 1, wherein the animal feed comprising DHA from a microbial source contains no animal-derived materials.

16. The composition of claim 1, wherein the animal feed comprising DHA from a microbial source contains no ethoxyquin.

17. The composition of claim 1, wherein the animal feed comprising DHA from a microbial source contains lecithin at a level of from 1-20 g lecithin/20 g DHA from the microbial source

18. A method of preparing a feed comprising DHA from a microbial source, the method comprising:
culturing heterotropic microalgae containing DHA in a culture medium comprising glucose;
harvesting and centrifuging biomass comprising the microalgae to form a thick paste;
drying and grounding said biomass into a fine powder.

19. The method of claim 18, wherein the DHA from the microbial source is present at from 0.01% to 1.5% DHA.

20. The method of claim 18, wherein the DHA from the microbial source is present at from 0.025% to 0.25% DHA.

21. The method of claim 18, wherein the DHA from the microbial source is from intact cells of Crypthecodinium or Schizochytrium or lipid extracts therefrom.

22. The method of claim 18, wherein the feed is an extruded feed or supplement.

23. The method of claim 18, wherein the feed is a pelleted feed or supplement.

24. The method of claim 18, wherein the biomass comprising microbial DHA is blended with lecithin at a level of from 1-20 g lecithin/20 g DHA from the microbial source.

25. A method of improving the neurological development of a young animal, the method comprising:
feeding the young animal's mother during the period of pregnancy or lactation with a feed comprising DHA from a microbial source, wherein the microbial source provides the primary source of DHA in the animal feed.

26. The method of claim 25 wherein the animal is selected from the group consisting of dog, cat, horse, pig, shrimp and salmon.

27.-31. (canceled)

32. The method of claim 25 where the DHA from the microbial source is from intact cells of Crypthecodinium or Schizochytrium or lipid extracts therefrom.

33. A method of improving the neurological development of a young animal by the feeding it through the first 25% of its lifetime with a feed comprising DHA from a microbial source, wherein the microbial source provides the primary source of DHA in the animal feed.

34. The method of claim 33 wherein the animal is selected from the group consisting of dog, cat, horse, pig, shrimp or salmon.

35.-39. (canceled)

40. The method of claim 23 where the DHA from the microbial source is from intact cells of Crypthecodinium or Schizochytrium or lipid extracts therefrom.
